(19) United States
(12) Patent Application Publication
(10) Pub. No.: US 2016/0216809 A1
(43) Pub. Date: Jul. 28, 2016

(54) LAMINATE FOR TOUCH PANEL

(71) Applicant: FUJIFILM Corporation, Tokyo (JP)

(72) Inventors: Michihiro SHIBATA, Ashigara-kami-gun (JP); Yasuhiro MITAMURA, Ashigara-kami-gun (JP); Shinya OGIKUBO, Ashigara-kami-gun (JP); Reiji HIGUCHI, Ashigara-kami-gun (JP)

(73) Assignee: FUJIFILM Corporation, Tokyo (JP)

(21) Appl. No.: 15/090,700

(22) Filed: Apr. 5, 2016

Related U.S. Application Data
(63) Continuation of application No. PCT/JP2014/076723, filed on Oct. 6, 2014.

(30) Foreign Application Priority Data
Oct. 9, 2013 (JP) 2013-212189

(51) Int. Cl. G06F 3/044; G06F 3/041

(52) U.S. Cl. CPC G06F 3/044; G06F 3/0412; G06F 2203/04112; G06F 2203/04107

(57) ABSTRACT

Provided is a laminate for a touch panel that is a laminate that is used in a touch panel, and that can prevent migration of wiring caused by incursion of moisture. The laminate for a touch panel includes a substrate; wiring that is formed on a surface of the substrate; and an adhesive layer that is in contact with the wiring and is provided on the substrate, in which moisture permeability of the adhesive layer is 40 g/(m²·day) or less, and a shortest distance from an end surface to the wiring is 500 μm or greater.

### CROSS-REFERENCE TO RELATED APPLICATIONS

This application is a Continuation of PCT International Application No. PCT/JP2014/076723 filed on Oct. 6, 2014, which claims priority under 35 U.S.C. §119(a) to Japanese Patent Application No. 2013-212189 filed on Oct. 9, 2013. The above application is hereby expressly incorporated by reference, in its entirety, into the present application.

### BACKGROUND OF THE INVENTION

1. Field of the Invention

The present invention relates to a laminate for a touch panel, and specifically, to a laminate for a touch panel that can prevent a short circuit of wiring caused by migration.

2. Description of the Related Art

Recently, the rate of mounting a touch panel to a portable phone or a portable game machine has increased, and thus, for example, a touch panel in an electrostatic capacitance system that can perform multipoint detection (hereinafter, simply referred to as a touch panel) has attracted attention.

In addition, in association with this increase in the rate of mounting a touch panel, various characteristics are required for the touch panel.

For example, as the configuration of the touch panel, a configuration in which wiring made of ITO or silver is formed on both surfaces of the substrate made of the resin film, an adhesive sheet is provided on both of the surfaces of the substrate, a glass plate is provided on an adhesive sheet, and a display device is disposed such that the display surface faces one glass plate has been known. In this touch panel using the adhesive sheet, the adhesive sheet becomes cloudy due to humidification, and thus there is a problem in that the visibility of the touch panel decreases or the appearance deteriorates.

In contrast, JP2011-99078A discloses an optical adhesive sheet including an adhesive agent layer containing a polymer including a monomer of which a glass-transition temperature at the time of forming a homopolymer is −10° C. or higher as an optical adhesive sheet that can prevent cloudiness due to the humidification in which a moisture content after the optical adhesive sheet preserved for 120 hours in the environment of 60° C. and 95% RH is 0.65 wt % or greater.

### SUMMARY OF THE INVENTION

In addition to this cloudiness, a wiring short circuit caused by the migration of wiring of a sensor portion (touch panel sensor) caused by humidification as the deterioration of the touch panel is known.

As is well-known, migration caused by humidification is a phenomenon in which ions of materials forming wiring are eluted and diffused by humidifying ITO or silver that becomes wiring. If this diffusion progresses, wiring of the sensor portion is short-circuited, and thus the touch panel does not appropriately operate.

However, recently, weight reduction, a thickness reduction, miniaturization, and the like are required in the touch panel.

Here, sensor wiring provided on the operation surface (operation area) and peripheral wiring which are provided on the external side of the operation surface and which connect an external portion and the sensor wiring to each other are provided in the sensor portion of the touch panel. In addition, decorative printing such as a frame is performed in the area for forming this peripheral wiring.

A method of narrowing down the width of this decorative printing is effective for miniaturizing the touch panel.

However, in order to narrow down the width of the decorative printing, it is necessary to narrow down the line width of the peripheral wiring and further narrow down an interval of the peripheral wiring. Further, if the width of the decorative printing is narrowed down, the distance between an end portion of the touch panel and the peripheral wiring is short, and the moisture easily reaches the peripheral wiring.

Therefore, recently, the sensor portion of the touch panel is in a state in which the migration is more easily generated, and thus the release of the touch panel in which the generation of the migration can be prevented is desired.

An object of the invention is to solve the problems in the related art and to provide a laminate for a touch panel that is used in a touch panel and that can prevent disorder or defects caused by the short circuit of wiring caused by migration for a long period of time even when the miniaturization of the touch panel is achieved by narrowing down the width of the decorative printing, since the generation of the migration of wiring in a sensor portion, particularly, peripheral wiring can be prevented.

In order to achieve the object of the invention, there is provided a laminate for a touch panel that is used in a touch panel for detecting an operation position on an operation surface and outputting a signal to the operation position, including:

a substrate; wiring that is formed on at least one surface of the substrate; and an adhesive layer that is in contact with the wiring and is provided on the substrate,

in which moisture permeability of the adhesive layer is 40 g/(m²·day) or less, and a shortest distance from an end surface to the wiring is 500 μm or greater.

In this laminate for the touch panel according to the invention, a shortest distance from an end surface to the wiring is preferably 2,000 μm or less.

In addition, it is preferable that a protection substrate having moisture permeability of 1×10⁻³ g/(m²·day) or less is laminated on one surface of the substrate or on both surfaces of substrate.

In addition, it is preferable that one of the protection substrates forms a portion of a display device provided on the touch panel.

In addition, it is preferable that expressions below are satisfied, when moisture permeability of the adhesive layer is T [g/(m²·day)], a thickness of the adhesive layer is t [μm], and a shortest distance from the end surface to the wiring is d [μm].

25≦t≦250

0.15≦d/(T×t)

In addition, it is preferable that the wiring is formed on both surfaces of the substrate, and the adhesive layer is provided on the wiring on both of the surfaces.

In addition, it is preferable that a first substrate and a second substrate are included as the substrate, the wiring is formed on one surface of the first substrate and one surface of the second substrate, the first substrate and the second substrate are disposed such that surfaces on which the wiring is formed face each other, and the adhesive layer is provided between both substrates.

Further, it is preferable that a first substrate and a second substrate are included as the substrate, the wiring is formed on one surface of the first substrate and one surface of the second substrate, the first substrate and the second substrate are disposed such that a surface on which wiring is formed and a surface on which the wiring is not formed face each other, and the adhesive layer is provided between both of the substrates.

According to the laminate for a touch panel of the invention, it is possible to prevent the migration of wiring caused by the moisture intruding particularly from the end surface of the laminate (touch panel).

Therefore, according to the laminate for a touch panel of the invention, short circuit of wiring caused by the migration is prevented, and thus it is possible to realize a highly durable touch panel that appropriately operates for a long period of time without generating operation failure caused by the short circuit of the wiring.

### BRIEF DESCRIPTION OF THE DRAWINGS

FIG. 1 is a diagram conceptually illustrating an example of a laminate for a touch panel of the invention.

FIG. 2 is a diagram conceptually illustrating a flat surface of the laminate for the touch panel illustrated in FIG. 1.

FIG. 3 is a diagram conceptually illustrating a cross section taken along line III-III of FIG. 2.

FIG. 4 is a diagram conceptually illustrating an example of wiring used in the laminate for the touch panel of the invention.

FIG. 5 is a diagram conceptually illustrating a configuration of another example of the laminate for the touch panel of the invention.

FIG. 6 is a diagram conceptually illustrating a configuration of another example of the laminate for the touch panel of the invention.

### DESCRIPTION OF THE PREFERRED EMBODIMENTS

Hereinafter, a laminate for a touch panel according to the invention is described in detail with reference to preferred examples illustrated in accompanying diagrams.

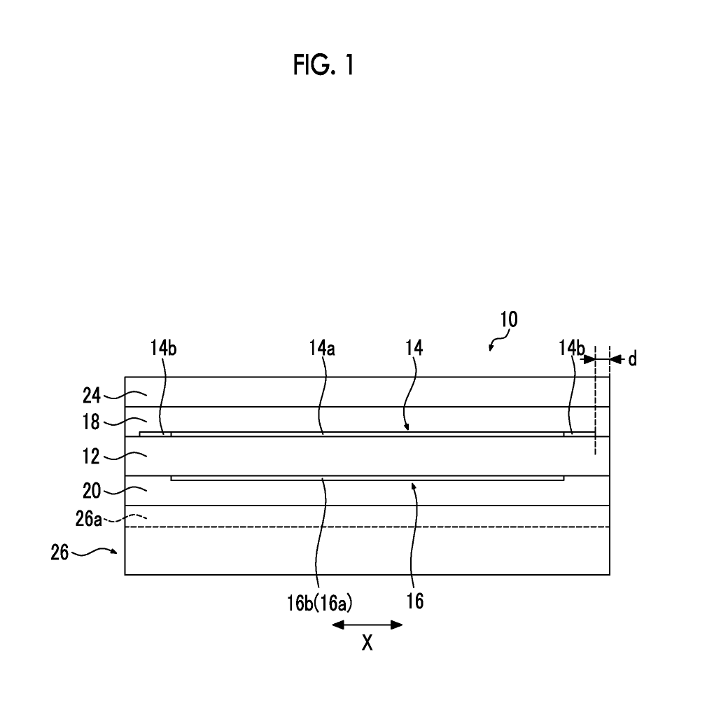

An example of the touch panel using the laminate for the touch panel of the invention is conceptually illustrated in FIG. 1.

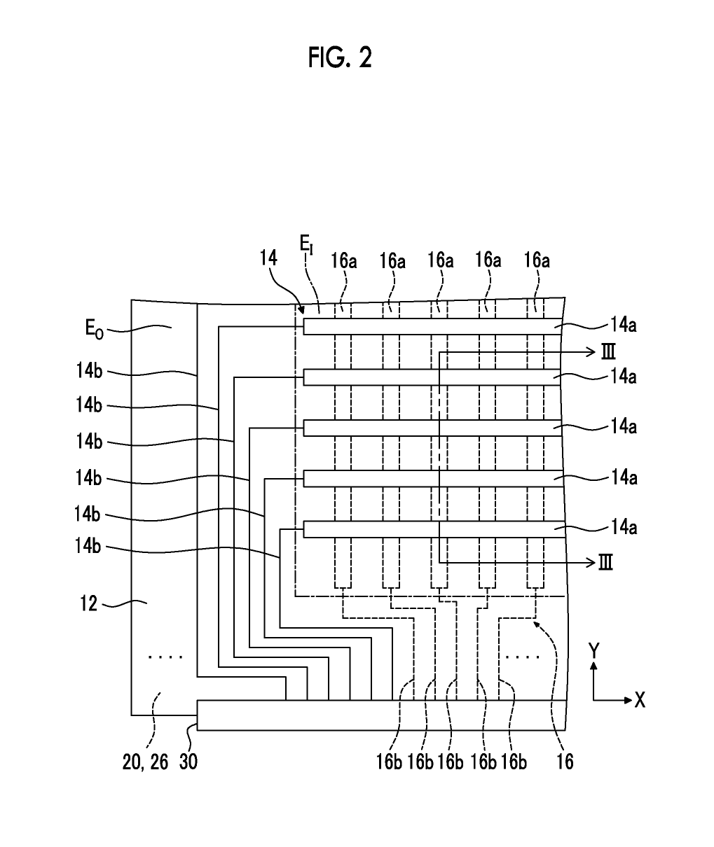

A touch panel 10 illustrated in FIG. 1 basically includes a substrate 12, a first wiring 14, a second wiring 16, a first adhesive layer 18, a second adhesive layer 20, a protection substrate 24, and a display device 26. Further, a flexible printed wiring board 30 is provided on the substrate 12 (see FIG. 2).

Specifically, the first wiring 14 is formed on one surface of the substrate 12, and the second wiring 16 is formed on the other surface of the substrate 12. In addition, the first adhesive layer 18 is formed to be in contact with the first wiring 14 and cover the first wiring 14 and the substrate 12, and the second adhesive layer 20 is formed to be in contact with the second wiring 16 and cover the second wiring 16 and the substrate 12.

The protection substrate 24 adheres to the surface of the first adhesive layer 18 (the surface on the opposite side of the substrate 12). In addition, the display device 26 adheres to the surface of the second adhesive layer 20 (the surface on the opposite side of the substrate 12) so as to cause the display surface to face the substrate 12 side. Here, the display device 26 has a protective layer 26a on the surface on the display surface side. The protective layer 26a operates as the protection substrate in the laminate for the touch panel of the invention.

In the touch panel 10, the surface of the protection substrate 24 becomes the operation surface.

The touch panel 10 of the illustrated example has two of the laminates for the touch panel (hereinafter, also referred to as the laminate according to the invention) according to the invention, which are a laminate including the substrate 12, the first wiring 14, and the first adhesive layer 18 and a laminate including the substrate 12, the second wiring 16, and the second adhesive layer 20.

In addition, the touch panel 10 using the laminate of the invention is basically the same as the well-known electrostatic capacitance type touch panel except for having characteristics of the moisture permeability of the first adhesive layer 18 and the second adhesive layer 20 (adhesive layer) and the shortest distance from the end surface to the first wiring 14 and the second wiring 16. Accordingly, in the same manner as the well-known electrostatic capacitance type touch panel, the touch panel 10 using the laminate according to the invention uses changes in electrostatic capacity generated when an external conductor such as a finger of a human is in contact with or comes close to an operation surface according to an operation performed on the operation surface, detects a position (operation position) of the external conductor on the operation surface, and outputs a signal corresponding to the position of the external conductor (a coordinate position in an X-Y direction on the operation surface).

The substrate 12 functions as a support in a laminate of the invention, wiring is formed on at least one surface (main surface), and an adhesive layer which is in contact with the wiring is further provided.

In the touch panel 10 of the illustrated example, the first wiring 14 is formed on one surface of the substrate 12, and the second wiring 16 is formed on the other surface, as described above. Further, a surface on which the first wiring 14 of the substrate 12 is formed is covered with the first adhesive layer 18, and a surface on which the second wiring 16 of the substrate 12 is formed is covered with the second adhesive layer 20.

With respect to the laminate according to the invention, the substrate 12 is preferably light transmissive (visible light transmissive). Specifically, the substrate 12 preferably has total light transmittance of 85% to 100%. Accordingly, it is possible to obtain the touch panel 10 having satisfactory visibility of an operation screen.

In addition, the substrate 12 preferably has insulation properties. In other words, the substrate 12 is preferably an insulating substrate. That is, the substrate 12 preferably functions as a layer for securing insulation properties between first sensor wiring 14a and second sensor wiring 16a.

As the material for forming the substrate 12, various materials that are used as a wiring substrate in the well-known touch panel can be used. Examples thereof include a resin, ceramics, and glass. Among these, since toughness is excellent, various resins are suitably used.

Specific examples of the resin for forming the substrate 12 include polyethylene terephthalate (PET), polyether sulfone, a poly acrylic resin, a polyurethane-based resin, polyester, polycarbonate (PC), polysulfone, polyamide, polyarylate, polyolefin, a cellulose-based resin, polyvinyl chloride, a cycloolefin resin (COP), and a triacetyl cellulose resin (TAC). Among these, since transparency is excellent, PET, COP, PC, and TAC are suitably exemplified.

In the laminate according to the invention, the substrate 12 may be a single layer as in the illustrated example or may be formed by laminating 2 or more layers. For example, if necessary, the substrate 12 may be a substrate on which a layer (film) for providing various functions such as an adhesion layer (easily bonded layer) or a light reflection preventing layer is formed on the surface (the surface such as the resin film above).

The thickness of the substrate 12 may be appropriately decided according to the size of the touch panel 10. Specifically, the thickness is preferably 5 μm to 350 μm and more preferably 30 μm to 150 μm. If the thickness of the substrate 12 is caused to be in the range described above, a desired transmittance of the visible light can be obtained, and also handling is easy. In addition, in a case where the substrate 12 has 2 or more layers, the total thickness thereof corresponds to the thickness above.

In the illustrated example, the shape of the flat surface of the substrate 12 in a plan view substantially has a rectangular shape, but the shape is not limited thereto. For example, the shape may be a round shape or a polygonal shape.

As described above, the first wiring 14 is formed on one surface of the substrate 12, and the second wiring 16 is formed on the other surface. A sensor portion (touch panel sensor) of the touch panel 10 is formed with the substrate 12, the first wiring 14, and the second wiring 16.

In the touch panel 10 in the illustrated example, the first wiring 14 includes the first sensor wiring 14a and first peripheral wiring 14b. The second wiring 16 includes the second sensor wiring 16a and second peripheral wiring 16b.

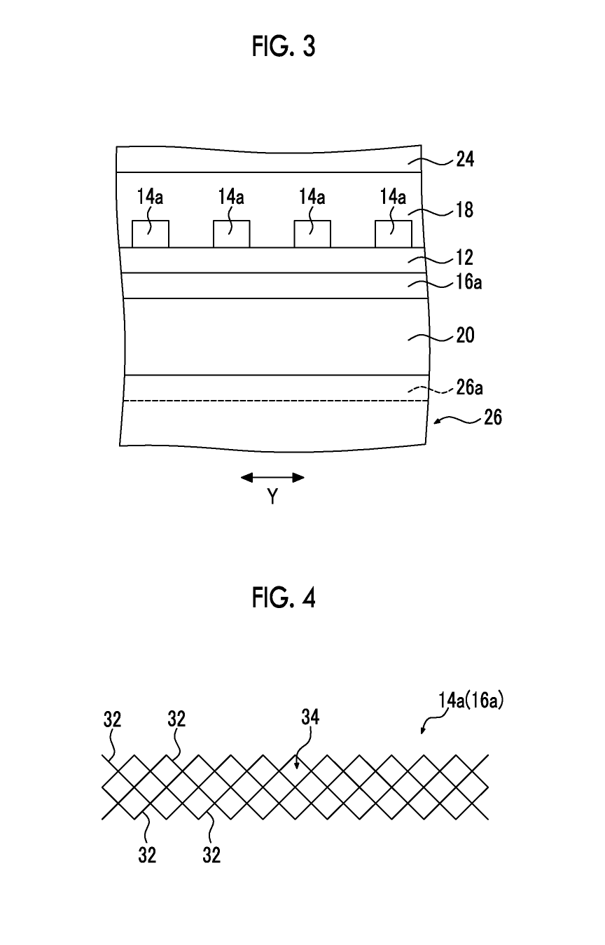

A plane view of the touch panel 10 is conceptually illustrated in FIG. 2, and a sectional view taken along line of FIG. 2 is illustrated in FIG. 3.

The plane view of FIG. 2 is a diagram illustrating the touch panel 10 seen from the operation surface side. In other words, the plane view of FIG. 2 is a diagram seen from a vertical direction of the operation surface, that is, the surface of the protection substrate 24. In addition, with respect to FIG. 2, in order to clearly illustrate the configuration of the touch panel 10 (particularly, the first wiring 14 and the second wiring 16), the first adhesive layer 18 and the protection substrate 24 are not illustrated.

The first sensor wiring 14a and the second sensor wiring 16a are sensing wirings that senses changes in electrostatic capacity in response to the operation by a finger of a user (external conductor). In the touch panel 10, an area in which the first sensor wiring 14a and the second sensor wiring 16a are formed becomes an input area E₁. In other words, the sensing wiring is a sensing electrode or a detecting electrode. In other words, the input area E1 is a sensing portion or a sensor portion.

That is, if the finger tip is brought into contact with the input area E₁ of the touch panel 10, mutual electrostatic capacity changes between the first sensor wiring 14a and the second sensor wiring 16a. The position of the finger tip is calculated with an IC circuit based on the change amount of the mutual electrostatic capacity.

With respect to the touch panel 10 of the illustrated example, the first sensor wiring 14a is formed to extend in the X direction in FIG. 2 (a direction vertical to the paper surface of FIG. 3). That is, the first sensor wiring 14a has a function of detecting an input position in the X direction of the finger of the user that comes close to the input area E_{I} and generating electrostatic capacity with the finger of the user. As illustrated in FIGS. 2 and 3, plural items of this first sensor wiring 14a are formed in a certain interval in the Y direction that is orthogonal to the X direction (direction vertical to the paper surface of FIG. 1).

In other words, the second sensor wiring 16a is formed to extend in the Y direction orthogonal to the X direction. That is, the second sensor wiring 16a has a function of detecting an input position of the finger of the user that comes close to the input area E_{I} in the Y direction and has a function of generating electrostatic capacity with the finger of the user. As illustrated in FIGS. 2 to 3, plural items of this second sensor wiring 16a are formed in a certain interval in the X direction.

In addition, the number and widths of the first sensor wiring 14a and the second sensor wiring 16a, and forming intervals thereof in the X and Y directions are appropriately determined depending on the size of the touch panel 10 or the detection resolution required in the input area E_{I}.

In addition, with respect to thicknesses of the first sensor wiring 14a and the second sensor wiring 16a, the thicknesses for securing the required strength and conductivity are appropriately determined depending on the forming material, the width, and the like.

Here, the first sensor wiring 14a and the second sensor wiring 16a may be wiring having a belt shape (plate shape) illustrated in FIG. 2, or may be wiring having a belt shape formed by combining plural conductive thin lines 32 as in an example thereof conceptually illustrated in FIG. 4.

If the first sensor wiring 14a and the second sensor wiring 16a are formed with the combination of the conductive thin lines 32, visibility and conductivity of a favorable display image of the display device 26 can be suitably secured even in a case where the first sensor wiring 14a and the second sensor wiring 16a are formed with a material without sufficient light transmissivity.

In this manner, in a case where the first sensor wiring 14a and the second sensor wiring 16a are formed with the conductive thin lines 32, in view of comparatively easily forming a low resistant electrode, the line width of the conductive thin lines 32 is preferably 30 μm or less, more preferably 15 μm or less, still more preferably 10 μm or less, particularly preferably 9 μm or less, and most preferably 7 μm or less. In addition, for the same reason, the line width of the conductive thin lines 32 is preferably 0.5 μm or greater and more preferably 1.0 μm or greater.

In view of conductive and visibility, the thicknesses of the conductive thin lines 32 can be selected from 0.01 μm to 200 μm. The thickness is preferably 30 μm or less, more preferably 20 μm or less, still more preferably 0.01 μm to 9 μm, and most preferably 0.05 μm to 5 μm.

In addition, in the example illustrated in FIG. 4, the conductive thin lines 32 are formed by combining four thin lines that that extend in one direction and bend at 90° in a predetermined width (amplitude). However, various configurations can be further used.

For example, the conductive thin lines 32 having a repetitive pattern of circular arcs and elliptical arcs, such as a sine curve may be combined, or the conductive thin lines 32 having a repetitive pattern of a polygon such as a quadrilateral may be combined.

That is, in addition to a quadrate shape in the illustrated example, the shape of an opening 34 formed by the conductive thin lines 32 may be various polygonal shapes (for example, a triangle, a quadrilateral, and a hexagon) or may be a circular shape or an elliptical shape. In addition, sides (lines) that form the opening 34 may have a curved shape or a circular arc shape, in addition to a straight line shape. In addition, in the case of the circular arc shape, for example, two sides that face each other may have an externally convex circular arc shape and the other two sides that face each other may have an internally convex circular arc shape. In addition, the shape of the respective sides may be a wave line shape in which externally convex circular arc shapes and internally convex circular arc shapes are repeated.

Further, the number of the conductive thin lines 32 that form one first sensor wiring 14a or one second sensor wiring 16a is not limited to four as in the illustrated example, but may be two, three, five, or more.

That is, the number of the conductive thin lines 32 that form one first sensor wiring 14a or one second sensor wiring 16a may be appropriately determined to be a number in which required conductive and visibility can be secured, depending on a repetitive pattern of the conductive thin lines 32, a pitch of the repetitive pattern, a width or thickness of the conductive thin lines 32, or the like.

In addition, when the first sensor wiring 14a or the second sensor wiring 16a is formed by combining the conductive thin lines 32, the length of one side of the opening 34 is preferably 800 μm or less, more preferably 600 μm or less, and preferably 400 μm or greater.

In addition, when the first sensor wiring 14a or the second sensor wiring 16a is formed with the conductive thin lines 32, in view of visible light transmittance, an opening ratio is preferably 85% or greater, more preferably 90% or greater, and most preferably 95% or greater. The opening ratio corresponds to a ratio in which a transparent portion except for the conductive thin lines 32 of the first sensor wiring 14a or the second sensor wiring 16a in a certain area occupies an entire body.

The first peripheral wiring 14b and the second peripheral wiring 16b connect the first sensor wiring 14a and the second sensor wiring 16a to the flexible printed wiring board 30, apply the voltage for generating electrostatic capacity (change in mutual electrostatic capacity) between the first sensor wiring 14a and the second sensor wiring 16a and the finger of the user, and detect a change of electrostatic capacity.

The first peripheral wiring 14b is formed on the substrate 12 of an external area E_{O} on the outside of the input area E_{I}, one end thereof is electrically connected to the corresponding first sensor wiring 14a and the other end thereof is electrically connected to the flexible printed wiring board 30. The second peripheral wiring 16b is also formed on the substrate 12 of the external area E_{O}, in the same manner, one end thereof is electrically connected to the corresponding second sensor wiring 16a, and the other end is electrically connected to the flexible printed wiring board 30.

In the touch panel 10, at a position corresponding to the external area E_{O} at which the first peripheral wiring 14b and the second peripheral wiring 16b are formed, so-called decorative printing (frame printing) is performed.

The flexible printed wiring board 30 is a plate obtained by providing plural items of wiring and plural terminals on a substrate. The flexible printed wiring board 30 is connected to respective other ends of the first peripheral wiring 14b and respective other ends of the second peripheral wiring 16b, and performs a function of connecting the substrate 12, the sensor portion including the first wiring 14 and the second wiring 16, and the external portion of the sensor portion (for example, the display device 26).

The first wiring 14 including the first sensor wiring 14a and the first peripheral wiring 14b and the second wiring 16 including the second sensor wiring 16a and the second peripheral wiring 16b may be formed of well-known conductive materials.

Specifically, metal such as gold (Au), silver (Ag), copper (Cu), or aluminum (Al) or an alloy thereof, and metallic oxide such as ITO, tin oxide, zinc oxide, cadmium oxide, gallium oxide, and titanium oxide are exemplified. In addition, the first wiring 14 and the second wiring 16 are made of a metallic paste such as a silver paste or a copper paste, a thin film of metal such as aluminum or molybdenum (Mo) or a thin film of an alloy. Among these, for the reason of excellent conductivity or the like, silver is suitably exemplified.

The first wiring 14 and the second wiring 16 may be formed by well-known methods that are used for manufacturing various touch panels.

For example, a metallic thin film is formed on the surface of the substrate 12 in a vapor phase deposition method such as sputtering, a photoresist film is formed on the metallic thin film, exposure and development treatments are performed on the photoresist film, a resist pattern is formed, and the metallic thin film exposed from the resist pattern is etched. In addition, a method of printing a paste including metallic fine particles and/or metal nanowire on the surface of the substrate 12 and performing metal plating on the paste can be used. Further, a method of using conductive ink or ink (paste) including metallic fine particles and forming the first wiring 14 or the second wiring 16 on the surface of the substrate 12 in a printing method such as screen printing or gravure printing or ink jetting can be used.

Further, a method of using silver halide can be exemplified, in addition to the methods above. Specifically, a method of forming the first wiring 14 or the second wiring 16 by performing a step of forming a silver halide emulsion layer (sensitive layer) containing silver halide and a binder on the surface of the substrate 12, a step of performing a development treatment after pattern exposure is performed on the sensitive layer by using light beam scanning or a photomask, and a step of heating wiring formed as required can be used. This method is more suitably used when the first sensor wiring 14a and the second sensor wiring 16a are formed by the aforementioned conductive thin lines 32.

In addition, in a case where the first wiring 14 or the second wiring 16 is formed according to this method, polysaccharide such as gelatin, carrageenan, polyvinyl alcohol (PVA), polyvinylpyrrolidone (PVP), and starch, cellulose and derivatives thereof, a binder such as polyethylene oxide, polysaccharide, polyvinylamine, chitosan, polylysine, a polyacrylic acid, a polyalginic acid, a polyhyaluronic acid, carboxy cellulose, gum arabic, and sodium alginate may exist between the first wiring 14 or the second wiring 16 (between the conductive thin lines 32 (the aforementioned opening 34)).

Here, in the laminate of the invention, a shortest distance d between wiring and an end surface of the laminate is 500 μm or greater. In other words, in the laminate of the invention, the shortest distance d between wiring and an end surface in the lamination structure of the substrate and the adhesive layer is 500 μm or greater. That is, in the laminate of the invention, the wiring is formed in the position separated from the end surface of the laminate by 500 μm or greater.

In the touch panel 10 of the illustrated example, the shortest distance d between the first wiring 14 and the end surface of the laminate including the substrate 12, the first wiring 14, and the first adhesive layer 18 is 500 μm or greater, and also the shortest distance d between the second wiring 16 and the end surface of the laminate including the substrate 12, the second wiring 16, and the second adhesive layer 20 is 500 μm or greater. That is, the first wiring 14 is formed at the position separated from the end surface of the laminate including the substrate 12, the first wiring 14, and the first adhesive layer 18 by 500 μm or greater, and also the second wiring 16 is formed at the position separated from the end surface of the laminate including the substrate 12, the second wiring 16, and the second adhesive layer 20 by 500 μm or greater.

This point is described below.

In addition, in a case where end portions of the substrate 12 and the adhesive layer are not matched to each other in the surface direction, the position of the end portion on the side on which the end portion is positioned on the inner side of the touch panel 10 becomes the end surface of the laminate of the substrate, the wiring, and the adhesive layer. That is, in a case where end portions of the substrate 12 and the adhesive layer are not matched to each other in the surface direction, the position of the end portion on the side on which the end portion does not protrude from the other side to the external portion becomes the end surface of the laminate of the substrate, the wiring, and the adhesive layer.

In other words, in a case where the end portions of the substrate 12 and the adhesive layer are not matched to each other in the surface direction, the end portions in an area in which the substrate 12 and the adhesive layer are laminated become the end surface of the laminate.

The first adhesive layer 18 is formed on the formation surface of the first wiring 14 of the substrate 12 so as to be in contact with the first wiring 14. Meanwhile, the first adhesive layer 18 is formed on the formation surface of the second wiring 16 of the substrate 12 so as to be in contact with the second wiring 16.

Both of the first adhesive layer 18 and the second adhesive layer 20 are layers having adhesiveness (bonding properties) and layers (films) having moisture permeability (water vapor permeability (water vapor transmittance)) of 40 g/(m²·day) or less. In addition, according to the invention, the moisture permeability of the adhesive layer is moisture permeability of a cup method in JIS Z0208 (Condition B: humidity of 40±0.5° C., and relative humidity of 90±0.2%) and is a value measured in a case where the thickness of the adhesive layer is 100 μm. That is, the moisture permeability of the adhesive layer per thickness of 100 μm is 40 g/(m²·day) or less.

The laminate of the invention is the laminate including a substrate used in the touch panel, wiring that is formed on the substrate surface, and an adhesive layer that covers the substrate and the wiring, in which the moisture permeability of the adhesive layer is 40 g/(m²·day) or less, and the shortest distance d between the wiring and the end portion of the laminate is 500 μm or greater, such that the generation of the migration of the wiring caused by the moisture is prevented, even if the width of the decorative printing is narrowed down.

That is, with respect to the touch panel 10 of the illustrated example, the first adhesive layer 18 and the second adhesive layer 20 having moisture permeability of 40 g/(m²·day) or less are used, and the shortest distance d between the first wiring 14 and the end surface of the laminate and the shortest distance d between the end surface of the laminate and the second wiring 16 are caused to be 500 μm or greater, such that the generation of the migration of the first wiring 14 and the second wiring 16 caused by the moisture can be prevented.

As described above, examples of the cause of the deterioration or the disorder of the touch panel include the migration of the wiring configuring the sensor portion of the touch panel and particularly a wiring short circuit caused by the migration of the peripheral wiring.

Particularly, recently, the weight reduction and the miniaturization of the touch panel are required, and the width of the corresponding decorative printing tends to be narrowed down. Therefore, the interval or the line width of the peripheral wiring is narrowed down, and the distance between the peripheral wiring and the end portion of the touch panel tends to be short.

Here, in the general touch panel, the adhesive layer is provided to cover the wiring and the substrate of the sensor portion, and a protection substrate such as a glass plate adheres to the surface of the adhesive layer. Therefore, the moisture that becomes the cause of the migration mainly intrudes from the end surface of the touch panel. That is, the end surface of the touch panel is an end surface of the laminate including the substrate, the wiring, and the adhesive layer.

Therefore, if the miniaturization or the weight reduction of the touch panel is attempted, the migration of the wiring is easily generated, and the wiring short circuit of the sensor portion caused by the migration is easily generated.

In contrast, with respect to the laminate according to the invention, if the moisture permeability of the adhesive layer is caused to be 40 g/(m²·day) or less, and the shortest distance d between the wiring and the end surface of the laminate is caused to be 500 μm or greater, it is possible to prevent the moisture intruding from the laminate, that is, the end portion of the touch panel 10 from reaching the wiring of the sensor portion.

Therefore, according to the laminate of the invention, the migration of the wiring of the sensor portion is prevented from being generated, the disorder or the malfunction caused by the wiring short circuit is prevented, and the touch panel 10 that exhibits appropriate performances for a long period of time and that has excellent durability can be obtained. With respect to the touch panel 10 of the illustrated example, the generation of the migration of the first peripheral wiring 14b and the second peripheral wiring 16b are particularly prevented, and thus excellent durability can be obtained.

If the moisture permeability of the adhesive layer (the first adhesive layer 18 and the second adhesive layer 20) exceeds 40 g/(m²·day), a sufficient effect of preventing the migration of the wiring cannot be obtained.

As described below, in the sensor portion of the touch panel, as the shortest distance d between the wiring and the end surface of the touch panel (laminate) becomes longer, a more excellent effect of preventing the migration of the wiring (migration properties) can be obtained. However, as described in the embodiment below, according to the examination by the inventors, if the moisture permeability of the adhesive layers (the first adhesive layer 18 and the second adhesive layer 20) is greater than 40 g/(m²·day), the generation of the migration of the wiring cannot be prevented, even if the shortest distance d is caused to be extremely long, for example, 5,000 μm or 7,000 μm.

In other words, in the laminate for the touch panel including the substrate, the wiring, and the adhesive layer, if the moisture permeability of the adhesive layer is caused to be 40 g/(m²·day) or less, the generation of the migration of the wiring of the sensor portion in the touch panel 10 can be specifically prevented.

Further, in view of obtaining a more suitable effect of preventing the migration of the wiring, the moisture permeability of the adhesive layer is preferably 30 g/(m²·day) or less, and particularly preferably 25 g/(m²·day) or less.

The thickness of the adhesive layer may be appropriately determined depending on the size or the thickness of the touch panel 10 and the required adhesive force (bonding force). Specifically, the thickness is preferably 25 μm to 250 μm and more preferably 50 μm to 200 μm.

If the thickness of the adhesive layer is greater than 250 μm, the effect of preventing the migration may decrease. It is considered that this is because moisture intruding openings from the side surface (end surface) of the adhesive layer become wider.

In contrast, when the thickness of the adhesive layer is less than 25 μm, the effect of preventing the migration may decrease. It is considered that this is because the adhesive layer may not completely absorb steps on a pasting surface, a gap may be generated, and thus an infiltration path of water may be formed.

Further, if moisture permeability T [g/(m²·day)], thickness t [μm] of the adhesive layer, and the shortest distance d [μm] between the wiring and the end surface described below are caused to be in the range in which the following four expressions are satisfied, it is possible to enhance the effect of preventing the migration.

T≦40

25≦t≦250

500≦d

0.15≦d/(T×t)

In addition, as in the example illustrated in FIG. 1, in a case where the adhesive layers are provided on both sides of the substrate 12, the thicknesses of both of the adhesive layers may be the same. However, in order to reduce the influence on electromagnetic noise from the display device 26, it is preferable that the second adhesive layer 20 on the display device 26 side is thicker than the first adhesive layer 18 on the operation surface side.

Specifically, the thickness of the first adhesive layer 18 on the operation surface side is preferably 25 μm to 100 μm, and the thickness of the second adhesive layer 20 on the surface on the display device 26 side is preferably 125 μm to 250 μm.

As the material (adhesive agent) that forms the adhesive layer, various materials can be used, as long as the materials can satisfy the moisture permeability. Examples thereof include an acrylic adhesive agent, a rubber-based adhesive agent, and a silicone-based adhesive agent. Among these, in view of excellent adhesiveness to the substrate 12 or the protection substrate 24 and causing the raw material cost to be low, the acrylic adhesive agent is preferable.

The acrylic adhesive agent preferably has a repeating unit (hereinafter, also referred to as a repeating unit X) derived from a (meth)acrylate monomer having an aliphatic hydrocarbon group with 6 or more carbon atoms (preferably 6 to 20 carbon atoms, and more preferably 8 to 18 carbon atoms).

In addition, the (meth)acrylate monomer refers to a monomer having a (meth)acryloyl group. The (meth)acrylate monomer is a concept including both an acrylate monomer and a methacrylate monomer, and the (meth)acryloyl group is a concept including both an acryloyl group and a methacryloyl group.

In view of reducing moisture permeability, the content of the repeating unit X in the acrylic adhesive agent is preferably 60 mol % or greater and more preferably 80 mol % or greater with respect to the entire repeating unit. The upper limit is not particularly limited, and may be 100 mol %.

One of the suitable embodiments of the acrylic adhesive agent is preferably an acrylic adhesive agent including a repeating unit (hereinafter, referred to as a repeating unit Y) derived from a (meth)acrylate monomer having a chain-shaped aliphatic hydrocarbon group with 6 or more carbon atoms and a repeating unit (hereinafter, referred to as a repeating unit Z) derived from a (meth)acrylate monomer having a cyclic chain-shaped aliphatic hydrocarbon group with 6 or more carbon atoms.

In addition, the suitable embodiment of the number of atoms in the repeating units Y and Z is the same as the suitable embodiment of the number of atoms in the repeating unit X described above.

Examples of the (meth)acrylate monomer having a chain-shaped aliphatic hydrocarbon group with 6 or more carbon atoms include 2-ethylhexyl (meth)acrylate, n-octyl (meth)acrylate, isooctyl (meth)acrylate, n-nonyl (meth)acrylate, isononyl (meth)acrylate, n-decyl (meth)acrylate, isodecyl (meth)acrylate, n-dodecyl (meth)acrylate, n-tridecyl (meth)acrylate, n-tetradecyl (meth)acrylate, n-hexadecyl (meth)acrylate, and stearyl (meth)acrylate.

In addition, the (meth)acrylate monomer having a cyclic chain-shaped aliphatic hydrocarbon group with 6 or more carbon atoms includes isobornyl (meth)acrylate, dicyclopentenyl (meth)acrylate, and dicyclopentanyl (meth)acrylate.

In view of reducing moisture permeability and excellent mechanical strength as the adhesive layer, the content of the repeating unit Y in the acrylic adhesive agent is preferably 10 mol % to 50 mol % with respect to the entire repeating unit.

The content of the repeating unit Z in the acrylic adhesive agent is not particularly limited. However, in view of reducing moisture permeability and excellent mechanical strength as the adhesive layer, the content thereof is preferably 50 mol % to 9 mol % with respect to the entire repeating unit.

This adhesive layer may be formed by the well-known methods.

For example, an adhesive layer is formed by preparing coating (a coating composition) obtained by adding a required component such as a photopolymerization initiator, an antioxidant, or a light stabilizer to a composition containing a compound (mixture of the acrylate monomer, polybutadiene, and a hydrogenated limonene resin) that becomes the adhesive layer, applying the coating on the surface of the substrate 12 on which wiring is formed, drying the coating, and performing a hardening treatment, if necessary. In addition, the hardening treatment may be performed after the protection substrate 24 or the display device 26 described below is adhered to the adhesive layer.

In addition, the film-shaped adhesive sheet created by using the composition as described above may be used to form an adhesive layer. An adhesive agent (a layer of an adhesive agent) is generally interposed between two sheets of releasable films, and thus the film-shaped adhesive sheet is bonded to the adhering portion of the substrate 12 or the protection substrate 24 to be used, after the releasable film is released. In a case where the film-shaped adhesive sheet is used, heating and/or pressurizing may be performed together for forming the adhesive layer.

In addition, the applying of the coating may be performed by the well-known method using a gravure coater, a comma coater, a bar coater, a knife coater, a die coater, a roll coater, and the like. Further, the hardening treatment may be performed by the well-known methods depending on the composition that becomes the adhesive layer, such as a thermosetting treatment or a photosetting treatment.

In addition, as described above, in the laminate according to the invention, the shortest distance d between the wiring and the end surface of the laminate (the touch panel 10) is 500 μm or greater. That is, in the illustrated example, the shortest distance d between the first wiring 14 (generally, the first peripheral wiring 14b) and the end surface of the laminate including the substrate 12, the first wiring 14, and the first adhesive layer 18, and the shortest distance d between the second wiring 16 (generally, the second peripheral wiring 16b) and the end surface of the laminate including the substrate 12, the second wiring 16, and the second adhesive layer 20 is 500 μm or greater.

If the shortest distance d between the wiring and the end surface of the laminate is less than 500 μm, a sufficient effect of preventing the migration of the wiring cannot be obtained. In other words, in the laminate according to the invention, the adhesive layer having moisture permeability of 40 g/(m²·day) or less is used, and the shortest distance d between the wiring and the end surface of the laminate is caused to be short, for example, 500 inn, such that the sufficient effect of preventing the migration of the wiring can be obtained, even if the width of the decorative printing (frame printing) is narrowed down.

Further, since a more suitable effect of preventing the migration of the wiring can be obtained, the shortest distance d between the wiring and the laminate is preferably 700 μm or greater and more preferably 1,000 μm or greater.

In other words, the shortest distance d between the wiring and the end surface of the laminate is preferably 2,000 μm or less.

In view of the effect of preventing the migration of the wiring, it is advantageous that the shortest distance d between the wiring and the end surface of the laminate is long. However, if the shortest distance d is greater than 2,000 μm, the width of the decorative printing may be caused to be wide, accordingly. In contrast, if the shortest distance d is caused to be 2,000 μm or less, the width of the decorative printing is caused to be narrow, and the miniaturization of the touch panel 10 can be suitably achieved.

In addition, in view of this point, the shortest distance d is more preferably 1,800 μm or less and particularly preferably 1,500 μm or less.

As illustrated in FIG. 1, in the touch panel 10, the protection substrate 24 is adhered (bonded) to the surface of the first adhesive layer 18.

Meanwhile, the display device 26 is adhered to the surface of the second adhesive layer 20 such that the display surface faces the second adhesive layer 20. Here, as described above, the display device 26 has the protective layer 26a on the surface on the display surface side, and the protective layer 26a functions as the protection substrate in the laminate according to the invention.

In order to protect the touch panel 10 from the external portion and also prevent the intrusion of the moisture in the surface direction of the touch panel 10 (laminate), the protection substrate 24 (the protective layer 26a) is provided as a preferable embodiment. In addition, with respect to the touch panel 10 of the illustrated example, the protection substrate 24 that adheres to the first adhesive layer 18 becomes the operation surface of the touch panel 10.

According to the invention, the protection substrate 24 (the protective layer 26a) is a plate-shaped member having moisture permeability of 1×10⁻³ g/(m²·day) or less.

Various substrates can be used as the protection substrate 24, as long as the substrates has moisture permeability of 1×10⁻³ g/(m²·day) or less.

Specifically, a resin film such as a glass plate, a resin-based plate, and a plastic film is exemplified. Specific examples of the resin-based plate or the resin film include polyesters such as PET and polyethylene naphthalate (PEN); polyolefins such as polyethylene (PE), polypropylene (PP), polystyrene, and EVA; and a vinyl-based resin. In addition, a plate material or a film made of PC, polyamide, polyimide, an acrylic resin, TAC, and COP is exemplified.

In addition, a material obtained by forming a membrane (a gas barrier membrane (a gas barrier layer)) exhibiting gas barrier properties such as silicon oxide, aluminum oxide, and silicon nitride on the surface of the plate material or the film can be suitably used as the protection substrate 24.

In addition, in the laminate according to the invention, in view of more securely preventing the migration of the wiring caused by the moisture, the moisture permeability of the protection substrate 24 is more preferably 1×10⁻⁴ g/(m²·day) or less, and particularly preferably 1×10⁻⁵ g/(m²·day) or less.

Further, with respect to the laminate of the invention, the protection substrate 24 is preferably light transmissive (visible light transmissive). Specifically, the protection substrate 24 preferably has total light transmittance of 85% to 100%. Accordingly, the touch panel 10 having favorable visibility of the operation screen can be obtained.

The display device 26 is a device for displaying an operation screen, and various well-known display devices (display) used in the touch panel 10 can be used.

Specifically, a cathode ray tube (CRT) display device, a liquid crystal display device (LCD), an organic EL display (OLED), a vacuum fluorescent display (VFD), a plasma display panel (PDP), a surface-conduction electron-emitter display (SED), a field emission display (FED), and electronic paper (E-Paper) are exemplified.

In addition, the display device 26 does not necessarily have to have a member that becomes a protection substrate in the laminate of the invention, as in the protective layer 26a. That is, in the laminate of the invention, the protection substrate is adhered to the second adhesive layer 20, the adhesive layer for the display device is formed on the surface, and the display device 26 is mounted on the adhesive layer for the display device.

In addition, in the touch panel 10 illustrated in FIG. 1, the protection substrate 24 and the protective layer 26a (the display device 26) are directly adhered to the adhesive layer. However, according to the invention, the protection substrate 24 or the protective layer 26a may be provided via any type of layer between the protection substrate 24 and the protective layer 26a (the display device 26).

For example, a plastic film such as a PET film is adhered to the second adhesive layer 20, an adhesive layer for a film is formed on the plastic film, and the protective layer 26a of the display device 26 may be adhered to the adhesive layer for the film. Further, the protection substrate 24 on the first adhesive layer 18 side may be also adhered via the plastic film or the adhesive layer for the film in the same manner.

In the laminate (the touch panel 10) according to the invention illustrated in FIGS. 1 to 3, the wiring and the adhesive layer are formed on both surfaces of the substrate 12. However, in addition to this configuration, various configurations can be used for the laminate of the invention.

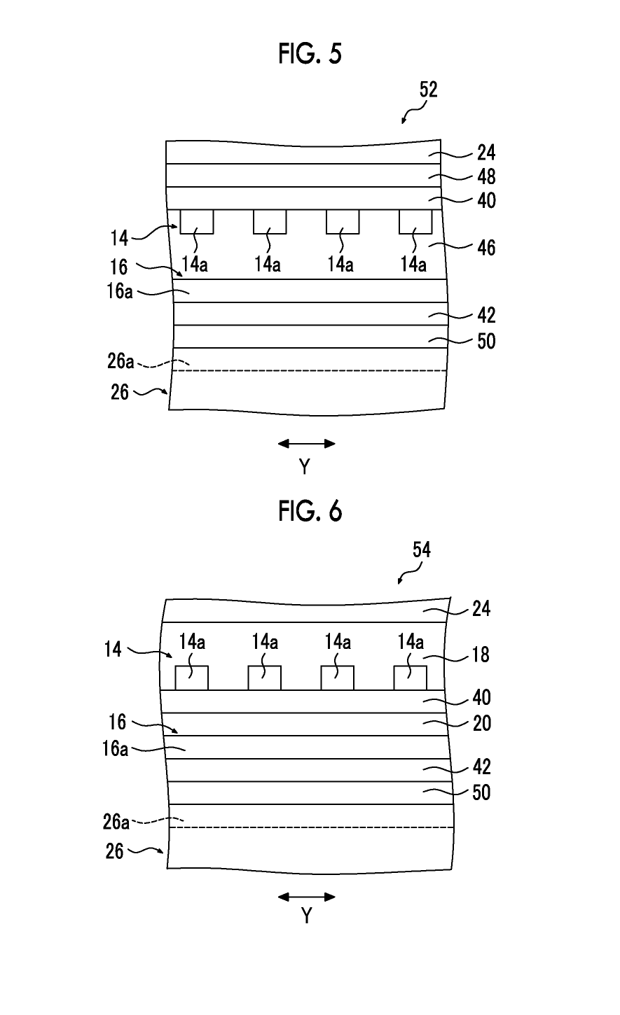

For example, a configuration conceptually illustrated in FIG. 5 is exemplified. In addition, in examples described below, the same member as illustrated in FIG. 1 or members which are the same with each other are used, and thus the same members are denoted by the same reference numerals, and the descriptions are mainly made with respect to different portions.

The example illustrated in FIG. 5 is an example in which two substrates of a first substrate 40 and a second substrate 42 are used.

Specifically, the first wiring 14 (the first sensor wiring 14a and the first peripheral wiring 14b (not illustrated)) is formed on one surface of the first substrate 40, and the second wiring 16 (the second sensor wiring 16a and the second peripheral wiring 16b (not illustrated)) is formed on one surface of the second substrate 42. Moreover, both of the substrates are bonded with an adhesive layer 46 such that the first wiring 14 and the second wiring 16 face each other.

That is, in the example illustrated in FIG. 5, two laminates of a laminate including the first substrate 40, the first wiring 14, and the adhesive layer 46 and a laminate including the second substrate 42, the second wiring 16, and the adhesive layer 46 are included.

Further, a protection substrate adhesive layer 48 is provided on the surface of the first substrate 40 (the surface on the opposite side of the wiring formation surface), the protection substrate 24 is adhered, a display device adhesive layer 50 is provided on the surface of the second substrate 42, and the display device 26 is adhered, such that a touch panel 52 is formed.

Another example of the laminate of the invention is illustrated in FIG. 6.

Also in the example in FIG. 6, two sheets of substrates are used, the first wiring 14 is formed on one surface of the first substrate 40, and the second wiring 16 is formed on one surface of the second substrate 42. However, the second adhesive layer 20 provided on the second substrate 42 is adhered to the surface of the first substrate 40 (the opposite surface to the wiring formation surface). Further, the protection substrate 24 is adhered to the first adhesive layer 18 provided on the first substrate 40, the display device adhesive layer 50 is provided on the surface of the second substrate 42, and the display device 26 is adhered, such that a touch panel 54 is formed.

That is, the example illustrated in FIG. 6 includes two laminates of a laminate including the first substrate 40, the first wiring 14, and the first adhesive layer 18 and a laminate including the second substrate 42, the second wiring 16, and the second adhesive layer 20.

Also, in addition to the above, in the laminate according to the invention, a configuration in which both of the first sensor wiring 14a and the second sensor wiring 16a are insulated by providing the first wiring 14 and the second wiring 16 on one surface of the substrate 12, and providing an insulating layer at an intersecting portion between the first sensor wiring 14a extending in the X direction and the second sensor wiring 16a extending in the Y direction and in which an adhesive layer is formed on the wiring formation surface of the substrate 12, by bringing the first wiring 14 and the second wiring 16 in contact with each other or the like can be used.

In addition, according to the invention, with respect to the protection substrate adhesive layer 48 that is not in contact with the first wiring 14 and the second wiring forming the sensor portion, the moisture permeability is not limited, and the moisture permeability may be greater than 40 g/(m²·day).

In the above, the laminate for the touch panel of the invention has been described in detail, but the invention is not limited to the above example, and various modifications and changes can be, of course, performed without departing from the gist of the invention.

### EXAMPLES

Hereinafter, the invention is described in detail with reference to examples, but the invention is not limited thereto.

### Example 1

A PET film having thickness of 100 μm was prepared as the substrate 12.

Comb-shaped wiring (L/S=30 μm/30 μm) having a width of 30 μm at an interval of 30 μm was formed on one surface of the substrate 12, and connection wiring for applying a voltage to the comb-shaped wiring were formed.

The comb-shaped wiring was formed such that the distance between the end portion of the comb tooth in the longitudinal direction and the end portion of the substrate 12 became 2,000 μm. In addition, the comb-shaped wiring was formed such that the distance between the end portion of the comb tooth in the longitudinal direction and the end portion of the substrate 12 became the shortest distance d between the end surface of the laminate and the wiring (that is, d=2,000 μm).

The forming of the comb-shaped electrode was performed as follows.

(Preparing of Silver Halide Emulsion)

To Liquid 1 below maintained at 38° C. and at pH of 4.5, Liquid 2 and Liquid 3 described below in respective amounts equivalent to 90% thereof were added together over 20 minutes under stirring, and core particles of 0.16 μm were formed. Subsequently, Liquid 4 and Liquid 5 described below were added over eight minutes, and further Liquid 2 and Liquid 3 described below in the remaining amounts of 10% were added over two minutes such that the particles were grown to 0.21 μm.

Further, 0.15 g of potassium iodide was added and ripened for five minutes, and the particle forming was completed.

| Liquid 1: | | |
|---|---|---|
| Water | 750 | ml |
| Gelatin | 9 | g |
| Sodium Chloride | 3 | g |
| 1,3-dimethylimidazolidine-2-thione | 20 | mg |
| Sodium Benzene Thiosulfonate | 10 | mg |
| Citric acid | 0.7 | g |
| Liquid 2: | | |
| Water | 300 | ml |
| Silver Nitrate | 150 | g |
| Liquid 3: | | |
| Water | 300 | ml |
| Sodium Chloride | 38 | g |
| Potassium Bromide | 32 | g |
| Potassium hexachloroiridate (III) | 8 | ml |
| (0.005% KCl 20% aqueous solution) | | |
| Ammonium Hexachlorinated Rhodiumate | 10 | ml |
| (0.001% NaCl 20% aqueous solution) | | |
| Liquid 4: | | |
| Water | 100 | ml |
| Silver Nitrate | 50 | g |
| Liquid 5: | | |
| Water | 100 | ml |
| Sodium Chloride | 13 | g |
| Potassium Bromide | 11 | g |
| Yellow Prussiate of Potash | 5 | mg |

Thereafter, in the common method, the particles were washed with water in a flocculation method. Specifically, the humidity was reduced to 35° C., the pH was reduced by using a sulfuric acid until silver halide was precipitated (in the range of pH3.6±0.2). Subsequently, three liters of the supernatant was removed (first washing with water). Further, three liters of distilled water was added, a sulfuric acid was added until silver halide was precipitated. Subsequently, three liters of the supernatant was removed (second washing with water). The same operation as the second washing with water was repeated once (third washing with water), and the water washing and desalting step was completed.

The emulsion after water washing and desalting was adjusted to pH6.4 and pAg7.5, 3.9 g of gelatin, 10 mg of sodium benzene thiosulfonate, 3 mg of sodium benzenethiosulfonate, 15 mg of sodium thiosulfate, and 10 mg of chloroauric acid were added, a chemical sensitization was performed such that the optimum sensitivity was able to be obtained at 55° C., and 100 mg of 1,3,3a,7-tetraazaindene as a stabilizer and 100 mg of PROXEL (Product name, manufactured by ICI Co., Ltd.) as a preservative were added.

The finally obtained emulsion was silver iodochlorobromide cubic particle emulsion including 0.08 mol % of silver iodide, in which a ratio of silver chlorobromide was 70 mol % of silver chloride and 30 mol % of silver bromide, an average particle diameter was 0.22 μm, and a coefficient of variation was 9%.

(Preparing of Composition for Forming Sensitive Layer)

1.2×10⁻⁴ mol/mol Ag of 1,3,3a,7-tetraazaindene, 1.2×10⁻² mol/mol Ag of hydroquinone, 3.0×10⁻⁴ mol/mol Ag of a citric acid, 0.90 g/mol Ag of 2,4-dichloro-6-hydroxy-1,3,5-triazine sodium salt were added to the emulsion, the pH of a coating liquid was adjusted to 5.6 by using a citric acid, such that a composition for forming the sensitive layer was obtained.

(Sensitive Layer Forming Step)

After a corona discharge treatment was performed on one surface of the substrate 12 described above, a gelatin layer having a thickness of 0.1 μm was provided on the surface to which the corona discharge treatment was performed as an undercoat layer, and an antihalation layer having an optical concentration of about 1.0 and including a dye decolored by alkali of a developer was further provided on the undercoat layer.

The prepared composition for forming the sensitive layer was applied to the antihalation layer, and further a gelatin layer having a thickness of 0.15 μm was provided, such that the substrate 12 having a sensitive layer formed on one surface was obtained. The formed sensitive layer had a silver amount of 6.0 g/m² and a gelatin amount of 1.0 g/m².

(Exposure Development Step)

The surface on which the sensitive layer of the substrate 12 was formed was irradiated with parallel light using a high pressure mercury lamp as a light source via a photomask corresponding to the comb-shaped wiring and the connection wiring described above, so as to perform exposure.

After the exposure, development was performed with the developer, a development treatment was performed by using a fixing solution (Product name: N3X-R for CN16X, manufactured by Fujifilm Corporation). Further, the layer was rinsed with pure water and dried, so as to obtain the substrate 12 on which connection wiring and comb-shaped wiring (L/S=30 μm/30 μm, and d=2,000 μm) made of Ag were formed on one side thereof.

Meanwhile, in a reaction vessel, 45 parts by mass of 2-ethylhexyl acrylate, 40 parts by mass of isobornyl acrylate, 12 parts by mass of dodecyl acrylate, 3 parts by mass of 2-hydroxyethyl acrylate, and 0.05 parts by mass of IRGACURE 184 (manufactured by Ciba Specialty Chemicals plc) as a polymerization initiator were mixed and irradiated with ultraviolet light using a low pressure mercury lamp for seven minutes after nitrogen substitution, so as to obtain an adhesive agent composition having viscosity of about 2,000 mPa·s.

A PET film having a thickness of 50 μm and being subjected to a releasing treatment on one surface with a silicone compound was coated with this adhesive agent composition such that the thickness after drying became 100 μm, the solvent was dried, and an adhesive sheet was obtained.

The obtained adhesive sheet and the PET film having a thickness of 38 μm and being subjected to the releasing treatment on one surface with the silicone compound were bonded to each other, and both surfaces were irradiated with a low pressure mercury lamp for five minutes, so as to obtain a transparent double-sided adhesive sheet having a thickness of 100 μm (an adhesive sheet A). This transparent double-sided adhesive sheet was used for the first adhesive layer 18 and the second adhesive layer 20.

The moisture permeability of this transparent double-sided adhesive sheet was measured in conformity with a cup method in JIS Z0208 (Condition B: humidity of 40±0.5° C., relative humidity of 90±0.2%).

As a result, the moisture permeability of this transparent double-sided adhesive sheet having a thickness of 100 μm was 40 g/(m²·day).

Subsequently, glass substrates having the same size as the substrate 12 and the thickness of 700 μm were bonded to both of the surfaces of the substrate 12 having the comb-shaped wiring and the connection wiring formed on one surface thereof as described above by using this transparent double-sided adhesive sheet, so as to obtain a laminate sample having the comb-shaped wiring, the first adhesive layer 18, and the glass plate on one side of the substrate 12 and the second adhesive layer 20, and the glass plate on the other side of the substrate 12.

### Examples 2 to 3 and Comparative Examples 1 to 2

Laminate samples each having the comb-shaped wiring, the first adhesive layer 18, and the glass plate on one side of the substrate 12 and having the second adhesive layer 20 and the glass plate on the other side of the substrate 12 were manufactured in the same manner as Example 1 except for causing the shortest distance d between the end portion of the comb-shaped electrode and the end portion of the substrate 12 to be 1,000 μm (Example 2), 500 μm (Example 3), 400 μm (Comparative Example 1), and 200 μm (Comparative Example 2).

### Examples 4 to 6 and Comparative Examples 3 to 4

In the reaction vessel, 30 parts by mass of 2-ethylhexyl acrylate, 60 parts by mass of isobornyl acrylate, 10 parts by mass of dodecyl acrylate, and 0.05 parts by mass of IRGACURE 184 (manufactured by Ciba Specialty Chemicals plc) as the polymerization initiator were mixed and irradiated with ultraviolet light using a low pressure mercury lamp for seven minutes after nitrogen substitution, so as to obtain an adhesive agent composition having viscosity of about 2,000 mPa·s.

The PET film having thickness of 50 μm and being subjected to the releasing treatment on one surface with the silicone compound was coated with this adhesive agent composition such that the thickness after drying became 100 μm, the solvent was dried, and an adhesive sheet was obtained.

The obtained adhesive sheet and the PET film having a thickness of 38 μm and being subjected to the releasing treatment on one surface with the silicone compound were bonded to each other, and both surfaces were irradiated with a low pressure mercury lamp for five minutes, so as to obtain a transparent double-sided adhesive sheet having a thickness of 100 μm (an adhesive sheet B). This transparent double-sided adhesive sheet was used for the first adhesive layer 18 and the second adhesive layer 20.

The moisture permeability of this transparent double-sided adhesive sheet having a thickness of 100 μm was measured in the same manner as in Example 1, and the moisture permeability was 25 g/(m²·day).

A laminate sample having the comb-shaped wiring, the first adhesive layer 18, and the glass plate on one surface of the substrate 12 and having the second adhesive layer 20 and the glass plate on the other surface of the substrate 12 was manufactured in the same manner as in Example 1 except for forming the first adhesive layer 18 and the second adhesive layer 20 by using the transparent double-sided adhesive sheet (Example 4).

Accordingly, in this example, the shortest distance d between the end portion of the comb-shaped electrode and the end portion of the substrate 12 was 2,000 μm as in Example 1.

Further, a laminate sample having the comb-shaped wiring, the first adhesive layer 18, and the glass plate on one surface of the substrate 12 and having the second adhesive layer 20 and the glass plate on the other surface of the substrate 12 was manufactured in the same manner as in Example 4 except for causing the shortest distance d between the end portion of the comb-shaped electrode and the end portion of the substrate 12 to be 1,000 μm (Example 5), 500 μm (Example 6), 400 μm (Comparative Example 3), and 200 μm (Comparative Example 4).

### Examples 7 to 9 and Comparative Examples 5 to 6

When 23 parts by mass of a hydrogenated limonene resin A (Product name: CLEARON P-85, manufactured by Yasuhara Chemical Co., Ltd.) having a softening point of 90° C. and 31 parts by mass of polybutadiene B having a molecular weight of 2,600 (Product name: POLYVEST 110, manufactured by Evonik Degussa GmbH) were mixed in under the condition of 150° C. and became even, the temperature of the liquid was caused to be 80° C.

15 parts by mass of dicyclopentenyl oxyethyl methacrylate (Product name: FANCRYL FA-512M, manufactured by Hitachi Chemical Co., Ltd.), 4 parts by mass of 2-hydroxybutyl methacrylate (Product name: LIGHTESTER HOB(N), manufactured by Kyoeisha Chemical Co., Ltd.), 3 parts by mass of isobornyl methacrylate (Product name: LIGHTESTER IB-X, manufactured by Kyoeisha Chemical Co., Ltd.), and 21 parts by mass of polyisoprene C in which a 0.8 mol % methacryloyloxy ethyl group was grafted (Product name: KURAPUREN UC-203, manufactured by Kuraray co., Ltd.) were mixed to this mixture, so as to obtain a prepolymer liquid.

Further, under the condition of 80° C., as the photopolymerization initiator, 2.3 parts by mass of 1-hydroxycyclohexyl phenyl ketone (Product name: IRGACURE184, manufactured by BASF SE), 0.7 parts by mass of (2,4,6-trimethylbenzoyl)diphenylphosphine oxide (Product name: LUCIRIN TPO, manufactured by BASF SE) were respectively added and stood still at room temperature, so as to manufacture a coating liquid S-1.

After the obtained coating liquid S-1 was applied to the peeled PET by using an applicator such that a thickness of the adhesive layer became 100 μm, the peeled PET was bonded thereto, and irradiation with UV light (3 J/cm²) was performed such that an adhesive layer was formed and thus a transparent double-sided adhesive sheet having a thickness of 100 μm was obtained (an adhesive sheet C). This transparent double-sided adhesive sheet was used as the first adhesive layer 18 and the second adhesive layer 20.

The moisture permeability of this transparent double-sided adhesive sheet having a thickness of 100 μm was measured in the same manner as in Example 1, and the moisture permeability was 27 g/(m²·day).

A laminate sample having the comb-shaped wiring, the first adhesive layer 18, and the glass plate on one surface of the substrate 12 and having the second adhesive layer 20 and the glass plate on the other surface of the substrate 12 was manufactured in the same manner as in Example 1 except for forming the first adhesive layer 18 and the second adhesive layer 20 by using this transparent double-sided adhesive sheet (Example 7).

Accordingly, in this example, the shortest distance d between the end portion of the comb-shaped electrode and the end portion of the substrate 12 was 2,000 μm as in Example 1.

Further, laminate samples each having the comb-shaped wiring, the first adhesive layer 18, and the glass plate on one surface of the substrate 12 and having the second adhesive layer 20 and the glass plate on the other surface of the substrate 12 were manufactured in the same manner as in Example 7 except for causing the shortest distance d between the end portion of the comb-shaped electrode and the end portion of the substrate 12 to be 1,000 μm (Example 8), 500 μm (Example 9), 400 μm (Comparative Example 5), and 200 μm (Comparative Example 6).

### Comparative Examples 7 to 12

In the reaction vessel, 50 parts by mass of 2-ethylhexyl acrylate, 30 parts by mass of isobornyl acrylate, 18 parts by mass of 2-hydroxyethyl acrylate, 2 parts by mass of an acrylic acid, and 0.05 parts by mass of IRGACURE 184 (manufactured by Ciba Specialty Chemicals plc) as a polymerization initiator were mixed and irradiated with ultraviolet light using a low pressure mercury lamp for seven minutes after nitrogen substitution, so as to obtain an adhesive agent composition having viscosity of about 2,000 mPa·s.

The PET film having thickness of 50 μm and being subjected to the releasing treatment on one surface with the silicone compound was coated with this adhesive agent composition such that the thickness after drying became 100 μm, the solvent was dried, and an adhesive sheet was obtained.

The obtained adhesive sheet and the PET film having a thickness of 38 μm and being subjected to the releasing treatment on one surface with the silicone compound were bonded to each other, and both surfaces were irradiated with a low pressure mercury lamp for five minutes, so as to obtain a transparent double-sided adhesive sheet having a thickness of 100 μm (an adhesive sheet D). This transparent double-sided adhesive sheet was used for the first adhesive layer 18 and the second adhesive layer 20.

The moisture permeability of this transparent double-sided adhesive sheet having a thickness of 100 μm was measured in the same manner as in Example 1, and the moisture permeability was 53 g/(m²·day).

A laminate sample having the comb-shaped wiring, the first adhesive layer 18, and the glass plate on one surface of the substrate 12 and having the second adhesive layer 20 and the glass plate on the other surface of the substrate 12 was manufactured in the same manner as in Example 1 except for forming the first adhesive layer 18 and the second adhesive layer 20 by using the transparent double-sided adhesive sheet and causing the shortest distance d between the end portion of the comb-shaped electrode and the end portion of the substrate 12 to be 7,000 μm (Comparative Example 7).

Laminate samples each having the comb-shaped wiring, the first adhesive layer 18, and the glass plate on one surface of the substrate 12 and having the second adhesive layer 20 and the glass plate on the other surface of the substrate 12 were manufactured in the same manner as in Comparative Example 7 except for causing the shortest distance d between the end portion of the comb-shaped electrode and the end portion of the substrate 12 to be 2,000 μm (Comparative Example 8), 1,000 μm (Comparative Example 9), 500 μm (Comparative Example 10), 400 μm (Comparative Example 11), and 200 μm (Comparative Example 12).

### Comparative Examples 13 to 15

In the reaction vessel, 45 parts by mass of 2-ethylhexyl acrylate, 40 parts by mass of isobornyl acrylate, 5 parts by mass of dodecyl acrylate, 10 parts by mass of 2-hydroxyethyl acrylate, and 0.05 parts by mass of IRGACURE 184 (manufactured by Ciba Specialty Chemicals plc) as a polymerization initiator were mixed and irradiated with ultraviolet light using a low pressure mercury lamp for seven minutes after nitrogen substitution, so as to obtain an adhesive agent composition having viscosity of about 2,000 mPa·s.

The PET film having thickness of 50 μm and being subjected to the releasing treatment on one surface with the silicone compound was coated with this adhesive agent composition such that the thickness after drying became 100 μm, the solvent was dried, and an adhesive sheet was obtained.

The obtained adhesive sheet and the PET film having a thickness of 38 μm and being subjected to the releasing treatment on one surface with the silicone compound were bonded to each other, and both surfaces were irradiated with a low pressure mercury lamp for five minutes, so as to obtain a transparent double-sided adhesive sheet having a thickness of 100 μm (an adhesive sheet E). This transparent double-sided adhesive sheet was used for the first adhesive layer 18 and the second adhesive layer 20.

The moisture permeability of this transparent double-sided adhesive sheet having a thickness of 100 μm was measured in the same manner as in Example 1, and the moisture permeability was 45 g/(m²·day).

A laminate sample having the comb-shaped wiring, the first adhesive layer 18, and the glass plate on one surface of the substrate 12 and having the second adhesive layer 20 and the glass plate on the other surface of the substrate 12 was manufactured in the same manner as in Example 1 except for forming the first adhesive layer 18 and the second adhesive layer 20 by using the transparent double-sided adhesive sheet and causing the shortest distance d between the end portion of the comb-shaped electrode and the end portion of the substrate 12 to be 5,000 μm (Comparative Example 13).

Laminate samples each having the comb-shaped wiring, the first adhesive layer 18, and the glass plate on one surface of the substrate 12 and having the second adhesive layer 20 and the glass plate on the other surface of the substrate 12 were manufactured in the same manner as in Comparative Example 13 except for causing the shortest distance d between the end portion of the comb-shaped electrode and the end portion of the substrate 12 to be 2,000 μm (Comparative Example 14) and 1,000 μm (Comparative Example 15).

### Examples 10 to 13

Laminate samples each having the comb-shaped wiring, the first adhesive layer 18, and the glass plate on one surface of the substrate 12 and having the second adhesive layer 20 and the glass plate on the other surface of the substrate 12 were manufactured in the same manner as in Example 5 except for causing the thickness (a thickness of the transparent double-sided adhesive sheet used as the adhesive layer) of the first adhesive layer 18 and the second adhesive layer 20 to be 250 μm (Example 10), 300 μm (Example 11), 25 μm (Example 12), and 20 μm (Example 13).

That is, the adhesive layer used in this example is the same as the adhesive sheet B, and the moisture permeability in the thickness of 100 μm was 25 g/(m²·day). In addition, the shortest distance d between the end portion of the comb-shaped electrode and the end portion of the substrate 12 was 1,000 μm.

[Migration Test]

A direct current voltage of 5 V in the environment of 85° C. and the relative humidity of 85%, was applied to the laminate samples in Examples 1 to 9 and the laminate samples in Comparative Examples 1 to 15 manufactured as described above for 200 hours.

Thereafter, the generation of the migration of the comb-shaped wiring was evaluated.

A laminate sample in which any one of a short circuit in wiring caused by migration, a change in shape or a change in color of wiring while the short circuit in the wiring was not generated, or a change in color between wirings was recognized was evaluated as B, and where none of those was recognized was evaluated as A.

In addition, with respect to the short circuit between wirings, when electric resistance between wirings was measured with a resistance measuring device, wire of which the electric resistance is decreased by 2 digits or more compared with the electric resistance before the test was determined to be a short circuit. In addition, a change in shape or a change in color of wirings or a change in color between wiring was observed with an optical microscope.

Results thereof are presented in the table below.

TABLE 1

| | | Adhesive layer moisture | Adhesive layer | Shortest | | |
|---|---|---|---|---|---|---|
| | | permeability T | thickness t | distance d | | |
| | Adhesive sheet | [g/m² · day] | [μm] | [μm] | d/(T × t) | Migration test |
| Example 1 | A | 40 | 100 | 2000 | 0.50 | A |
| Example 2 | A | 40 | 100 | 1000 | 0.25 | A |
| Example 3 | A | 40 | 100 | 500 | 0.13 | A |
| Comparative | A | 40 | 100 | 400 | 0.10 | B |
| Example 1 | | | | | | |
| Comparative | A | 40 | 100 | 200 | 0.05 | B |
| Example 2 | | | | | | |
| Example 4 | B | 25 | 100 | 2000 | 0.80 | A |
| Example 5 | B | 25 | 100 | 1000 | 0.40 | A |
| Example 6 | B | 25 | 100 | 500 | 0.20 | A |
| Comparative | B | 25 | 100 | 400 | 0.16 | B |
| Example 3 | | | | | | |
| Comparative | B | 25 | 100 | 200 | 0.08 | B |
| Example 4 | | | | | | |
| Example 7 | C | 27 | 100 | 2000 | 0.74 | A |
| Example 8 | C | 27 | 100 | 1000 | 0.37 | A |
| Example 9 | C | 27 | 100 | 500 | 0.19 | A |
| Comparative | C | 27 | 100 | 400 | 0.15 | B |
| Example 5 | | | | | | |
| Comparative | C | 27 | 100 | 200 | 0.07 | B |
| Example 6 | | | | | | |
| Comparative | D | 53 | 100 | 7000 | 1.32 | B |
| Example 7 | | | | | | |
| Comparative | D | 53 | 100 | 2000 | 0.38 | B |
| Example 8 | | | | | | |
| Comparative | D | 53 | 100 | 1000 | 0.19 | B |
| Example 9 | | | | | | |
| Comparative | D | 53 | 100 | 500 | 0.09 | B |
| Example 10 | | | | | | |
| Comparative | D | 53 | 100 | 400 | 0.08 | B |
| Example 11 | | | | | | |
| Comparative | D | 53 | 100 | 200 | 0.04 | B |
| Example 12 | | | | | | |
| Comparative | E | 45 | 100 | 5000 | 1.11 | B |
| Example 13 | | | | | | |
| Comparative | E | 45 | 100 | 2000 | 0.44 | B |
| Example 14 | | | | | | |
| Comparative | E | 45 | 100 | 1000 | 0.22 | B |
| Example 15 | | | | | | |
| Example 10 | B | 25 | 250 | 1000 | 0.16 | A |
| Example 11 | B | 25 | 300 | 1000 | 0.13 | A |
| Example 12 | B | 25 | 25 | 1000 | 1.60 | A |
| Example 13 | B | 25 | 20 | 1000 | 2.00 | A |

Thicknesses of the first adhesive layer and the second adhesive layer are the same.

As presented in the table above, in all laminate samples according to the invention that satisfied the conditions in which the moisture permeability of the adhesive layer was 40 g/(m²·day) or less and the shortest distance d from the end portion (the end surface of the laminate) to the wiring was 500 μm or greater, the migration of the comb-shaped wiring was prevented.

In addition, all examples except for Examples 2, 3, 11, and 13 were under the environment of 85° C. and the relative humidity of 85%, and thus even if the direct current voltage of 5 V was applied for 500 hours or longer, the evaluation was A. In addition, Example 2 at the time point greater than 400 hours and Examples 3, 11, and 13 at the time point greater than 300 hours were in the evaluation B state.

In contrast, even if the moisture permeability of the adhesive layer was 40 g/(m²·day) or less, Comparative Examples 1 to 6 in which the shortest distance d was 500 μm or less have a short shortest distance d, and thus in all of Comparative Examples 1 to 6, moisture reached the comb-shaped wiring, and thus it is considered that the migration of the comb-shaped wiring was generated.

Further, in Comparative Examples 7 to 12 in which the moisture permeability of the adhesive layer was 53 g/(m²·day) and Comparative Examples 13 to 15 in which the moisture permeability was 45 g/(m²·day), even if the shortest distance d from the end portion of the laminate to the wiring was caused to be extremely long, for example, 7,000 μm (Comparative Example 7) or 5,000 μm (Comparative Example 13), the moisture reached the comb-shaped wiring, and thus the migration of the comb-shaped wiring was generated.

In view of the results above, the effect of the invention is clear.

### EXPLANATION OF REFERENCES

10, 52, 54: touch panel
12: substrate
14: first wiring
14a: first sensor wiring
14b: first peripheral wiring
16: second wiring
16a: second sensor wiring
16b: second peripheral wiring
18: first adhesive layer
20: second adhesive layer
24: protection substrate
26: display device
26a: protective layer
30: flexible printed wiring board
32: conductive thin line
34: opening
40: first substrate
42: second substrate
46: adhesive layer
48: protection substrate adhesive layer
50: display device adhesive layer

What is claimed is:

1. A laminate for a touch panel that is used in a touch panel for detecting an operation position on an operation surface and outputting a signal to the operation position, comprising:
a substrate;
wiring that is formed on at least one surface of the substrate; and
an adhesive layer that is in contact with the wiring and is provided on the substrate,
wherein moisture permeability of the adhesive layer is 40 g/(m²·day) or less, and
a shortest distance from an end surface to the wiring is 500 μm or greater.

2. The laminate for a touch panel according to claim 1,
wherein a shortest distance from an end surface to the wiring is 2,000 μm or less.

3. The laminate for a touch panel according to claim 1,
wherein a protection substrate having moisture permeability of 1×g/(m²·day) or less is laminated on one surface of the substrate or on both surfaces of substrate.

4. The laminate for a touch panel according to claim 2,
wherein a protection substrate having moisture permeability of 1×10⁻³ g/(m²·day) or less is laminated on one surface of the substrate or on both surfaces of substrate.

5. The laminate for a touch panel according to claim 3,
wherein one of the protection substrates forms a portion of a display device provided on the touch panel.

6. The laminate for a touch panel according to claim 4,
wherein one of the protection substrates forms a portion of a display device provided on the touch panel.

7. The laminate for a touch panel according to claim 1,
wherein expressions below are satisfied, when moisture permeability of the adhesive layer is T [g/(m²·day)], a thickness of the adhesive layer is t [μm], and a shortest distance from the end surface to the wiring is d [μm].
25≦t≦250
0.15≦d/(T×t)

8. The laminate for a touch panel according to claim 2,
wherein expressions below are satisfied, when moisture permeability of the adhesive layer is T [g/(m²·day)], a thickness of the adhesive layer is t [μm], and a shortest distance from the end surface to the wiring is d [μm].
25≦t≦250
0.15≦d/(T×t)

9. The laminate for a touch panel according to claim 3,
wherein expressions below are satisfied, when moisture permeability of the adhesive layer is T [g/(m²·day)], a thickness of the adhesive layer is t [μm], and a shortest distance from the end surface to the wiring is d [μm].
25≦t≦250
0.15≦d/(T×t)

10. The laminate for a touch panel according to claim 4,
wherein expressions below are satisfied, when moisture permeability of the adhesive layer is T [g/(m²·day)], a thickness of the adhesive layer is t [μm], and a shortest distance from the end surface to the wiring is d [μm].
25≦t≦250
0.15≦d/(T×t)

11. The laminate for a touch panel according to claim 5,
wherein expressions below are satisfied, when moisture permeability of the adhesive layer is T [g/(m²·day)], a thickness of the adhesive layer is t [μm], and a shortest distance from the end surface to the wiring is d [μm].
25≦t≦250
0.15≦d/(T×t)

12. The laminate for a touch panel according to claim 6,
wherein expressions below are satisfied, when moisture permeability of the adhesive layer is T [g/(m²·day)], a thickness of the adhesive layer is t [μm], and a shortest distance from the end surface to the wiring is d [μm].
25≦t≦250
0.15≦d/(T×t)

13. The laminate for a touch panel according to claim 1,
wherein the wiring is formed on both surfaces of the substrate, and
the adhesive layer is provided on the wiring on both of the surfaces.

14. The laminate for a touch panel according to claim 2,
wherein the wiring is formed on both surfaces of the substrate, and
the adhesive layer is provided on the wiring on both of the surfaces.

15. The laminate for a touch panel according to claim 3,
wherein the wiring is formed on both surfaces of the substrate, and
the adhesive layer is provided on the wiring on both of the surfaces.

16. The laminate for a touch panel according to claim 1,
wherein a first substrate and a second substrate are included as the substrate,
the wiring is formed on one surface of the first substrate and one surface of the second substrate,
the first substrate and the second substrate are disposed such that surfaces on which the wiring is formed face each other, and
the adhesive layer is provided between both substrates.

17. The laminate for a touch panel according to claim 2,
wherein a first substrate and a second substrate are included as the substrate,
the wiring is formed on one surface of the first substrate and one surface of the second substrate,
the first substrate and the second substrate are disposed such that surfaces on which the wiring is formed face each other, and
the adhesive layer is provided between both substrates.

18. The laminate for a touch panel according to claim 3,
wherein a first substrate and a second substrate are included as the substrate,
the wiring is formed on one surface of the first substrate and one surface of the second substrate,
the first substrate and the second substrate are disposed such that surfaces on which the wiring is formed face each other, and
the adhesive layer is provided between both substrates.

19. The laminate for a touch panel according to claim 1,
wherein a first substrate and a second substrate are included as the substrate,
the wiring is formed on one surface of the first substrate and one surface of the second substrate,
the first substrate and the second substrate are disposed such that a surface on which wiring is formed and a surface on which wiring is not formed face each other, and
the adhesive layer is provided between both of the substrates.

20. The laminate for a touch panel according to claim 2,
wherein a first substrate and a second substrate are included as the substrate,
the wiring is formed on one surface of the first substrate and one surface of the second substrate,
the first substrate and the second substrate are disposed such that a surface on which wiring is formed and a surface on which wiring is not formed face each other, and
the adhesive layer is provided between both of the substrates.
